(19) United States
(12) Patent Application Publication
(10) Pub. No.: US 2026/0105389 A1
(43) Pub. Date: Apr. 16, 2026

(54) DETERMINING TARGET CANDIDATES AND INDIRECT CANDIDATES IN A DIRECTED GRAPH FOR PROBLEM RESOLUTION

(71) Applicant: INTERNATIONAL BUSINESS MACHINES CORPORATION, ARMONK, NY (US)

(72) Inventors: Dong Chen, Beijing (CN); Ming Lei Zhang, BEIJING (CN); Ting Ting Zhan, Beijing (CN); Yuan Jie Zhang, Ningbo (CN); Yin Xi Guo, Beijing (CN)

(21) Appl. No.: 18/916,244

(22) Filed: Oct. 15, 2024

(51) Int. Cl. G06Q 10/0631; G06Q 10/067; G06Q 10/10

(52) U.S. Cl. CPC G06Q 10/063112; G06Q 10/067; G06Q 10/103

(57) ABSTRACT

A weighted directed graph is initialized with measures corresponding to screened candidates for providing an answer to a question. Candidate scores are calculated via the weighted directed graph. Indirect candidates are grouped based on a secondary analysis performed via the weighted directed graph. Target candidates and candidate groups that contain the indirect candidates are matched via calculations performed via the weighted directed graph, wherein the indirect candidates are suitable for providing an answer to the question.

### BACKGROUND

Embodiments relate to a method, system, and computer program product for determining target candidates and indirect candidates in a directed graph for problem resolution.

A directed graph is a graph that is made up of a set of vertices connected by directed edges. Weighted directed graphs are directed graphs with weights assigned to their directed edges.

Question-and-answering services are information systems that allow users to ask and answer questions. Directed graphs have been used in Question-and-answering services to model asymmetric relationships among different types of nodes, where the directed graphs include elements corresponding to questions, answers, and users.

In graph theory, the Katz centrality of a node is a measure of centrality of the node in a network. It may be used to measure the relative degree of influence of an actor (or node) within a social network. Unlike typical centrality measures which consider only the shortest path between a pair of actors, Katz centrality measures take into account the total number of walks between a pair of actors. A Katz index may be used to describe the similarity between two actors.

### SUMMARY

Provided are a method, system, and computer program product in which a weighted directed graph is initialized with measures corresponding to screened candidates for providing an answer to a question. Candidate scores are calculated via the weighted directed graph. Indirect candidates are grouped based on a secondary analysis performed via the weighted directed graph. Target candidates and candidate groups that contain the indirect candidates are matched via calculations performed via the weighted directed graph, wherein the indirect candidates are suitable for providing an answer to the question.

In additional embodiments the calculations include computing Katz index between nodes of the weighted directed graph, wherein each node of the weighted directed graph represents a user or a candidate, and wherein the Katz index that is computed between two nodes of the weighted directed graph is a measure of a relationship between the two nodes of the weighted directed graph.

In further embodiments, in response to encountering the question, a technology area is identified, and in response to identifying the technology area, suitable candidates who can support the technology area are identified and the weighted directed graph initialized, and a Katz metric is calculated to provide scores.

In certain embodiments, a candidate group is determined to identify an indirect candidate, subsequent to calculating a Katz indicator.

In additional embodiments, operations performed comprise: determining a first Katz indicator of an indirect candidate and a user; determining a second Katz indicator of the indirect candidate and the candidate; and in response to determining that both the first and the second indicators are higher than the Katz indicator of the user and the candidate, the indirect candidate is validated as an entity to use.

In further embodiments, for lecture type activities unidirectional edges are placed in the weighted directed graph, wherein for discussion type activities bidirectional edges are placed in the weighted directed graph.

In certain embodiments, a plurality of nodes in a path between two nodes are considered while computing a Katz index for determining an indirect candidate.

### BRIEF DESCRIPTION OF THE DRAWINGS

Referring now to the drawings in which like reference numbers represent corresponding parts throughout:

FIG. 1 illustrates a block diagram of a computing environment, in accordance with certain embodiments.

FIG. 2 illustrates a flowchart that shows exemplary operations to determine candidates for consultation on questions, in accordance with certain embodiments.

FIG. 3 illustrates a block diagram that shows exemplary operations for screening candidates and determining candidate groups, in accordance with certain embodiments.

FIG. 4 illustrates a block diagram that shows operations performed by a candidate screening module, in accordance with certain embodiments.

FIG. 5 illustrates a block diagram that shows operations performed by a candidate determination module, in accordance with certain embodiments.

FIG. 6 illustrates a block diagram that shows initialization of a directed graph and mechanisms to provide weight to edges, in accordance with certain embodiments.

FIG. 7 illustrates a block diagram that shows mechanisms for computing weight between adjacent nodes, in accordance with certain embodiments.

FIG. 8 illustrates a block diagram that shows operations for computing Katz indicators and scores, in accordance with certain embodiments.

FIG. 9 illustrates a block diagram that shows mechanisms for secondary analysis, in accordance with certain embodiments.

FIG. 10 illustrates a block diagram that shows mechanisms for screening out indirect candidates, in accordance with certain embodiments.

FIG. 11 illustrates a block diagram that shows mechanisms for computing a Katz index, in accordance with certain embodiments.

FIG. 12 illustrates a block diagram that shows mechanisms for determining indirect candidates, in accordance with certain embodiments.

FIG. 13 illustrates a block diagram that shows mechanisms for indirect candidacy based on a threshold, in accordance with certain embodiments.

FIG. 14 illustrates a block diagram that shows a user interface to enable indirect candidates, in accordance with certain embodiments.

FIG. 15 illustrates a flowchart that shows exemplary operations, in accordance with certain embodiments.

FIG. 16 illustrates a computing environment in which certain components may be implemented, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

When individuals encounter problems in their daily work, they may need to find solutions to the problems through various channels within the organizational structure. The channels used may include instant messaging tools, websites, etc. In certain situations, the channels may be used to ask questions to colleagues, perform a web search, or ask questions in a group. One of the objectives may be to find the most suitable person to consult with, for resolving the problems.

This conventional approach is inefficient and often does not yield the desired results. Moreover, even if there is a way to provide appropriate consultants, there is a high probability that users and consultants may have never met or interacted with each other, and in such situations the effectiveness of problem solving, via the consultant, may be greatly reduced.

Certain embodiments provide mechanisms that use a weighted directed graph to find suitable candidates (e.g., a consultant), and implement secondary analysis based on actual work conditions to provide an indirect candidate screening method. In certain embodiments, a suitable list of candidates may be found quickly and effectively, including performing secondary analysis on the candidates, and under appropriate circumstances, providing indirect candidates to facilitate the formation of a suitable discussion team. Such embodiments, while effectively providing target candidates, also effectively expands the scope of the relationship network to achieve desirable results that improve the operations of a computational device that provides a question-and-answering service.

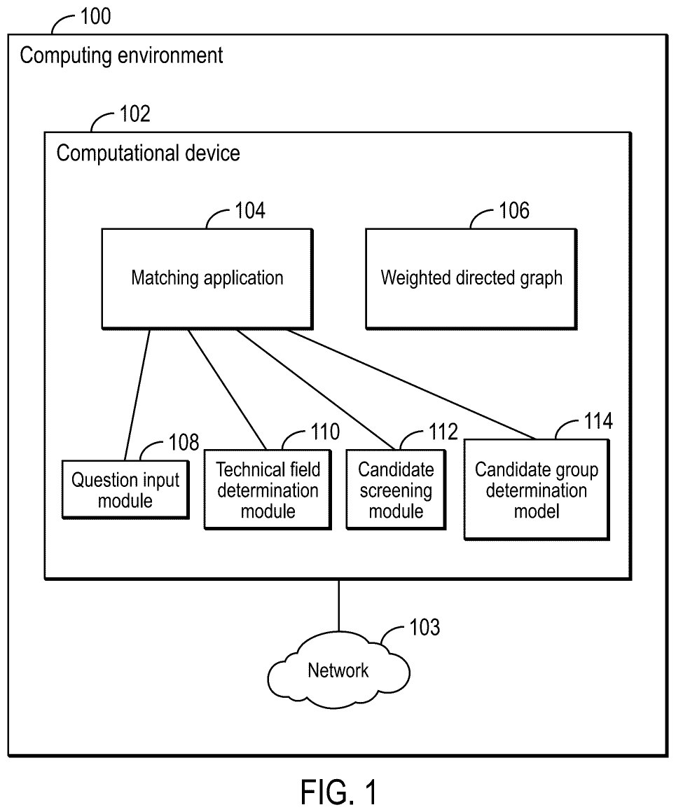

FIG. 1 illustrates a block diagram of a computing environment 100, in accordance with certain embodiments.

The computing environment 100 is comprised of a computational device 102 coupled to a network 103. The computational device 102 executes a matching application 104 that analyzes a weighted directed graph 106 to determine a suitable list of candidates for consultation in an organization. In certain embodiments, matching application 104 may be implemented in hardware, firmware, software, or any combination thereof.

The computational devices 102 may in certain embodiments comprise any suitable computational device known in the art such as a client, a server, a personal computer, a laptop, a mainframe, a telephony device, etc. The network 103 may comprise any suitable network known in the art such as the Internet, a local area network, a wide area network, etc.

Certain embodiments include four major modules that implement the matching application 104: a question input module 108, a technical field determination module 110, a candidate screening module 112, and a candidate group determination module 114.

In the candidate screening module 112, a directed graph is created and initialized based on the organizational framework and organizational activities, the weights of the directed edges are initialized and updated, impact factors related to time and times are defined, and candidate scores are calculated and provided. The result is the weighted directed graph 106.

In the candidate group determination module 114, a secondary analysis is performed. The condition triggered by secondary analysis occurs when the only candidate currently has a distant relationship with the user, and then a secondary analysis may be performed, in which a group formed by indirect candidates and candidates may be provided as a group. The candidate group determination module 114 defines the indirect candidate range, performs calculations and analysis of the weighted directed graph 106 and identifies indirect candidates.

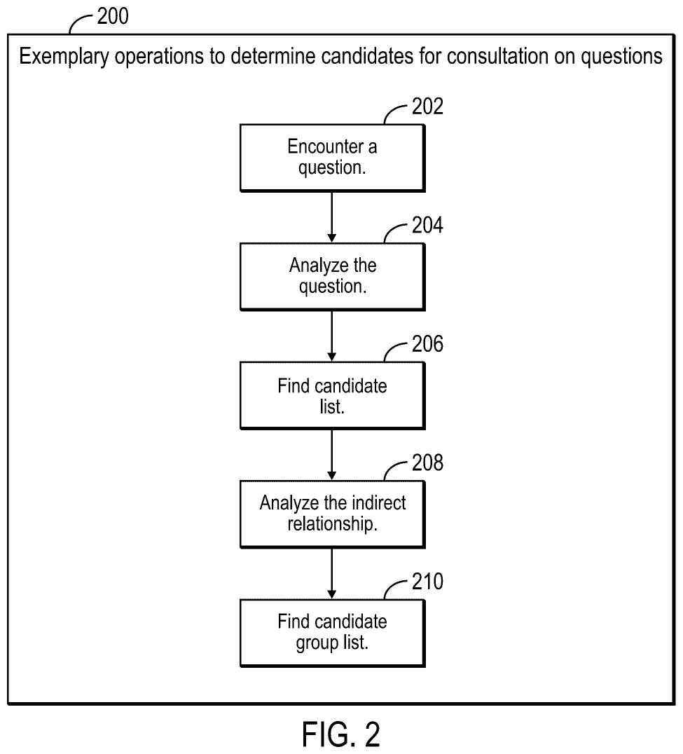

FIG. 2 illustrates a flowchart 200 that shows exemplary operations to determine candidates for consultation on questions, in accordance with certain embodiments. In certain embodiments, the operations shown in FIG. 2 may be executed by the matching application 104 that executes in the computational device 102. screening of candidates, allowing users, candidates, and intermediaries to participate in the process of discussing and solving problems, which has a positive role in providing effective help and improving user experience.

Control starts at block 202 in which a question is encountered, The question is analyzed (at block 204) and a candidate list is determined (at block 206). Indirect relationships are analyzed (at block 208) and a candidate group list found (at block 210).

Certain embodiments perform screening of candidates, allowing users, candidates, and intermediaries to participate in the process of discussing and solving problems, and this has a positive role in providing effective help and improving user experience. In contrast, earlier mechanisms may have selected candidates that were unfamiliar to the users and have never met them. In such earlier mechanisms, the enthusiasm of the candidates to participate and provide effective help may have been uncertain.

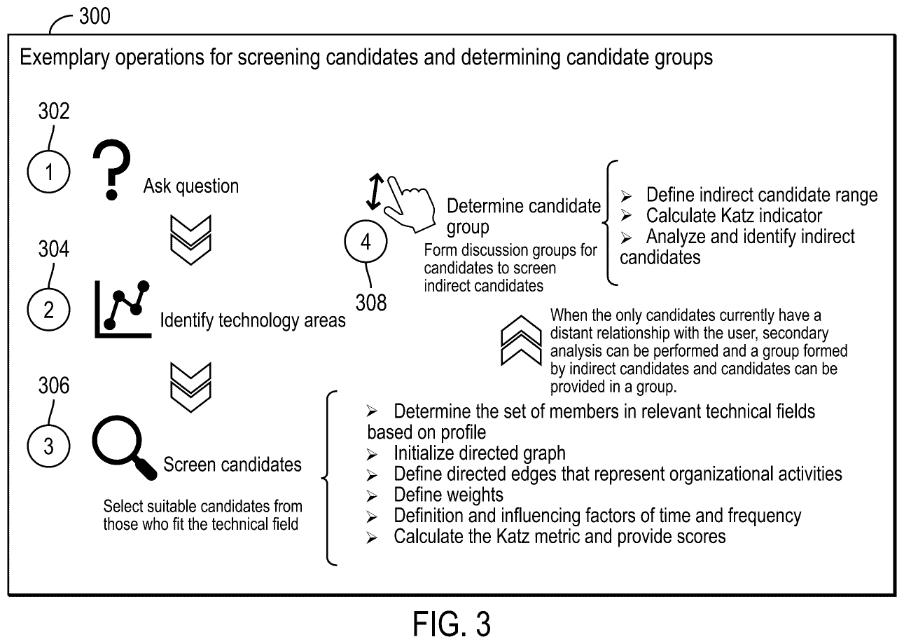

FIG. 3 illustrates a block diagram 300 that shows exemplary operations for screening candidates and determining candidate groups, in accordance with certain embodiments.

In a first set of operations 302 a question is asked. Technology areas are identified in a second set of operations 304. Control proceeds to perform a third set of operations 306 in which candidates are screened to select suitable candidates from those who fit the technical field by operations that perform the following:
1) Determine the set of members in relevant technical fields based on profile;
2) Initialize directed graph;
3) Define directed edges that represent organizational activities;
4) Define weights;
5) Provide definition and influencing factors of time and frequency; and
6) Calculate the Katz metric and provide scores.

Following the third set of operations 306, a fourth set of operations 308 to determine a candidate group is performs in which the process forms discussion groups for candidates to screen indirect candidates. When the only candidates currently have a distant relationship with the user, a secondary analysis may be performed and a group formed by indirect candidates and candidates may be provided in a group. The process performs the following operations:
(i) Define indirect candidate range.
(ii) Calculate Katz indicator.
(iii) Analyze and identify indirect candidates.

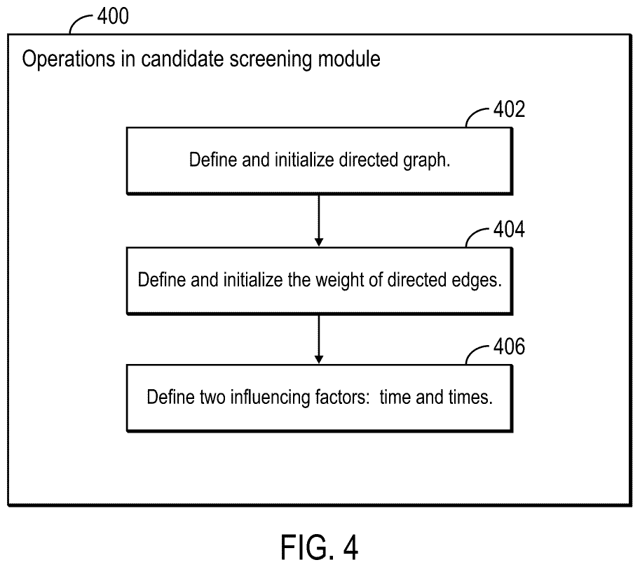

FIG. 4 illustrates a block diagram 400 that shows operations performed by the candidate screening module 112, in accordance with certain embodiments.

A directed graph is defined and initialized (at block 402). Control proceeds to block 404 in which the process defines and initializes the weight of the directed graph and then defines (at block the two influencing factors of time and the times associated with the directed graph.

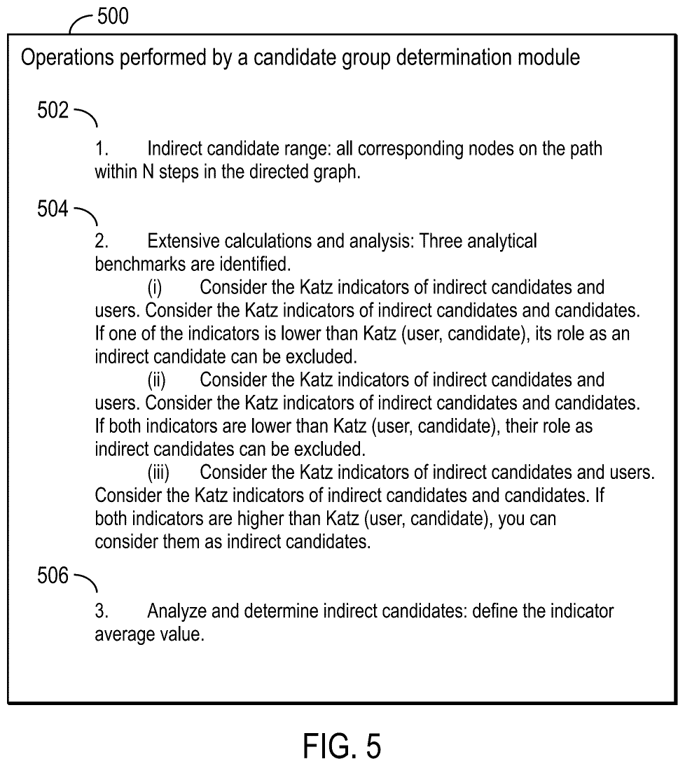

FIG. 5 illustrates a diagram 500 that shows operations performed by the candidate group determination module 114, in accordance with certain embodiments.

Control starts at block 502 in which an indirect candidate range in which all corresponding nodes on the path within N steps in the directed graph 106 are determined.

Control proceeds to block 504 in which extensive calculations and analysis are performed by identifying the three analytical benchmarks below:
1. Consider the Katz indicators of indirect candidates and users. Consider the Katz indicators of indirect candidates and candidates. If one of the indicators is lower than Katz (user, candidate), its role as an indirect candidate can be excluded.
2. Consider the Katz indicators of indirect candidates and users. Consider the Katz indicators of indirect candidates and candidates. If both indicators are lower than Katz (user, candidate), their role as indirect candidates can be excluded.
3. Consider the Katz indicators of indirect candidates and users. Consider the Katz indicators of indirect candidates and candidates. If both indicators are higher than Katz (user, candidate), you can consider them as indirect candidates.

Control then proceeds to block 506 in which the process analyzes and determines indirect candidates in which the process defines an indicator average value.

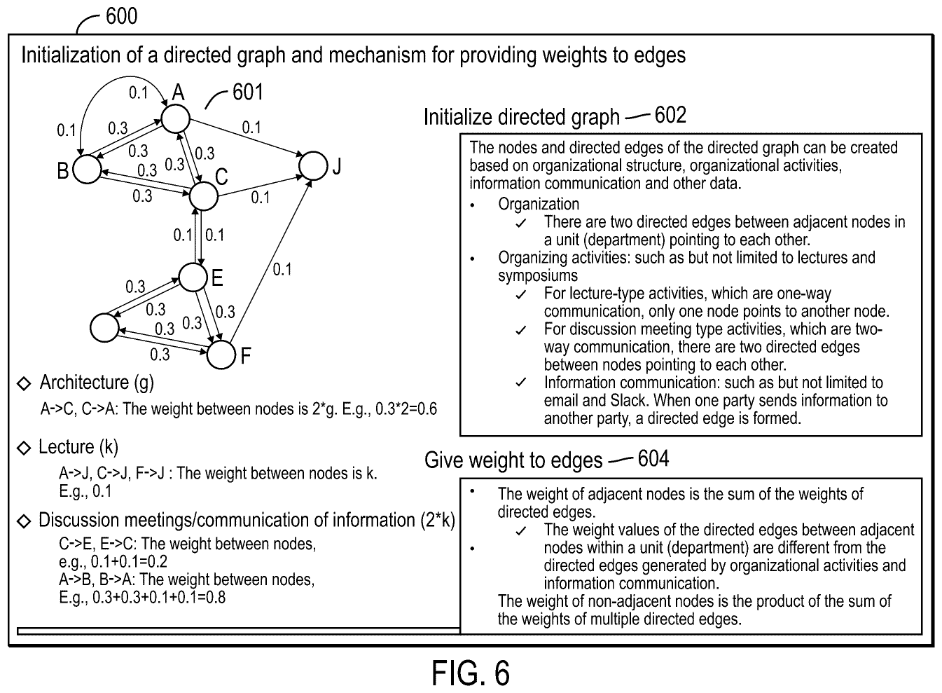

FIG. 6 illustrates a block diagram 600 that shows initialization of a directed graph and mechanisms to provide weight to edges, in accordance with certain embodiments. In FIG. 6 an exemplary weighted directed graph 601 is shown and the operations for initialization of the directed graph are shown via reference numeral 602, and the operations for giving weight to edges shown via reference numeral 604.

During initialization of the direct graph the nodes and directed edges of the directed graph may be created based on organizational structure, organizational activities, information communication and other data.

With regard to organization, there are two directed edges between adjacent nodes in a unit (department) pointing to each other. Organizing activities may include lectures and symposiums but are not limited to that. For lecture-type activities, which are one-way communication, only one node points to another node. For discussion meeting type activities, which are two-way communication, there are two directed edges between nodes pointing to each other. Information communication may include email and messaging applications. When one party sends information to another party, a directed edge is formed.

With regards to providing weight to edges, the weight of adjacent nodes is the sum of the weights of directed edges. The weight values of the directed edges between adjacent nodes within a unit (department) are different from the directed edges generated by organizational activities and information communication. The weight of non-adjacent nodes is the product of the sum of the weights of multiple directed edges.

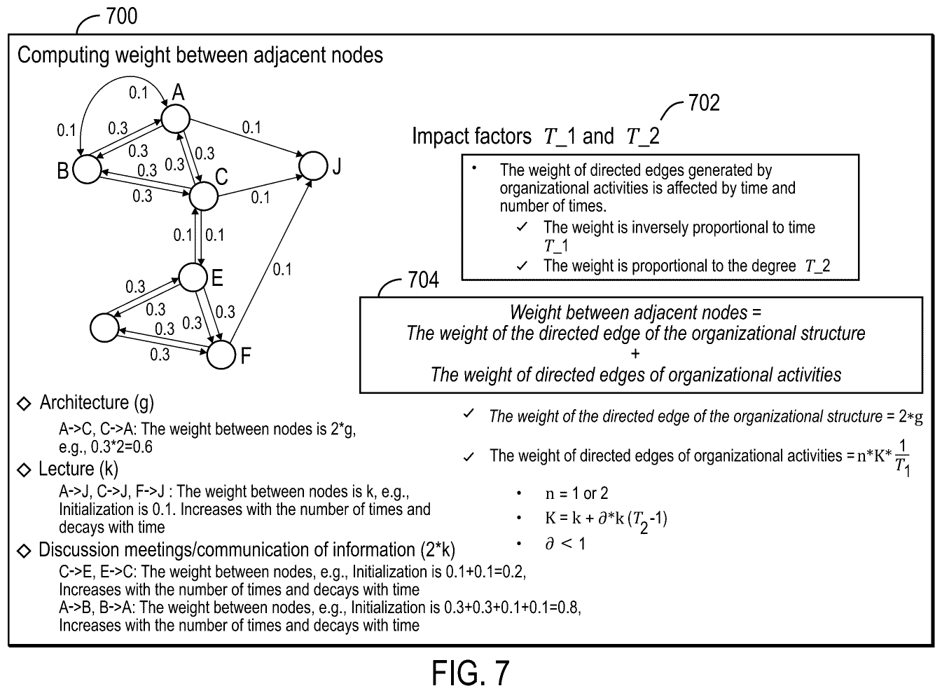

FIG. 7 illustrates a block diagram 700 that shows mechanisms for computing weight between adjacent nodes, in accordance with certain embodiments. Two impact factors T_1 and T_2 are calculated as shown by reference numeral 702. The weight of directed edges generated by organization activities is affected by time and number of times. The weight is inversely proportional to time T_1. The eight is proportional to the degree T_2.

The weight between adjacent nodes equals the sum of the weight of the directed edge of the organizational structure and the weight of directed edges of organizational activities and this is shown via reference numeral 704.

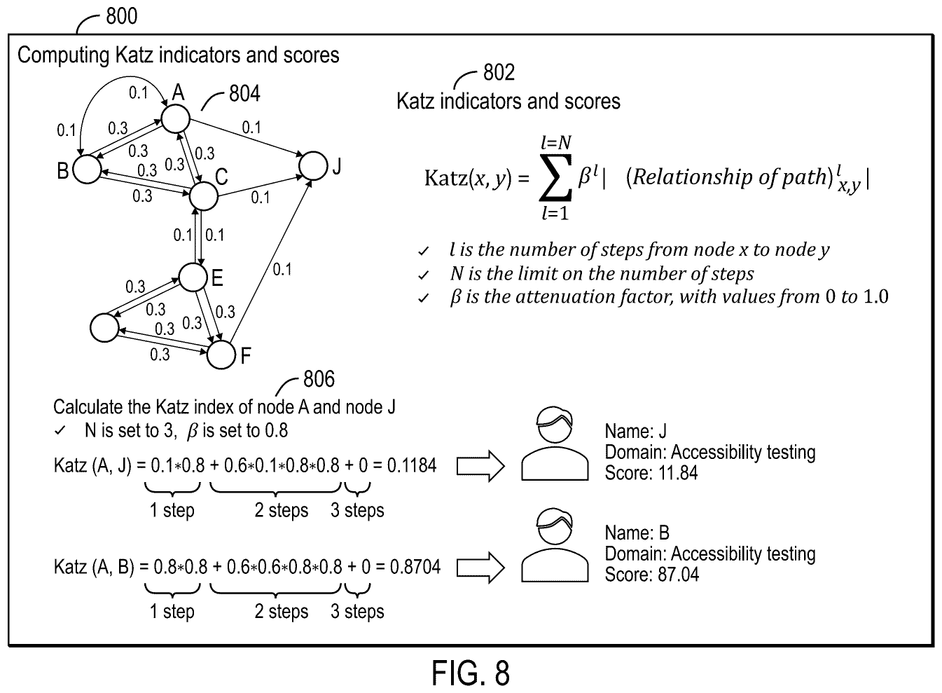

FIG. 8 illustrates a block diagram 800 that shows operations for computing Katz indicators and scores, in accordance with certain embodiments. Reference numeral 802 shows an exemplary formula for computing Katz indicators and scores in the weighted directed graph 804. Katz indexes of exemplary nodes are shown as being calculated (reference numeral 806).

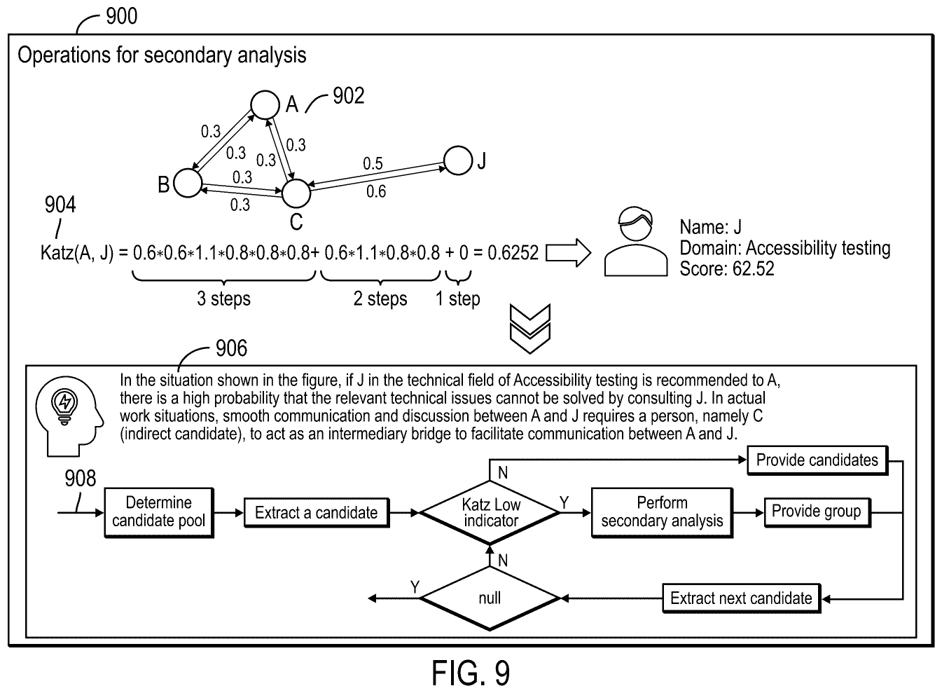

FIG. 9 illustrates a block diagram 900 that shows mechanisms for secondary analysis, in accordance with certain embodiments.

The Katz indicator between two nodes A and J are computed (as shown via reference numerals 902, 904) to arrive at a score. In the situation shown in the FIG. 9, if J in the technical field of Accessibility testing is recommended to A, there is a high probability that the relevant technical issues cannot be solved by consulting J. In actual work situations, smooth communication and discussion between A and J requires a person, namely C (indirect candidate), to act as an intermediary bridge to facilitate communication between A and J (shown via reference numeral 906).

The sequence of operations performed by the process includes determining a candidate pool, then extracting a candidate, and using the Katz indicator values to determine whether to perform secondary analysis and provide a group (as shown via the sequence of operations shown from reference numeral 908).

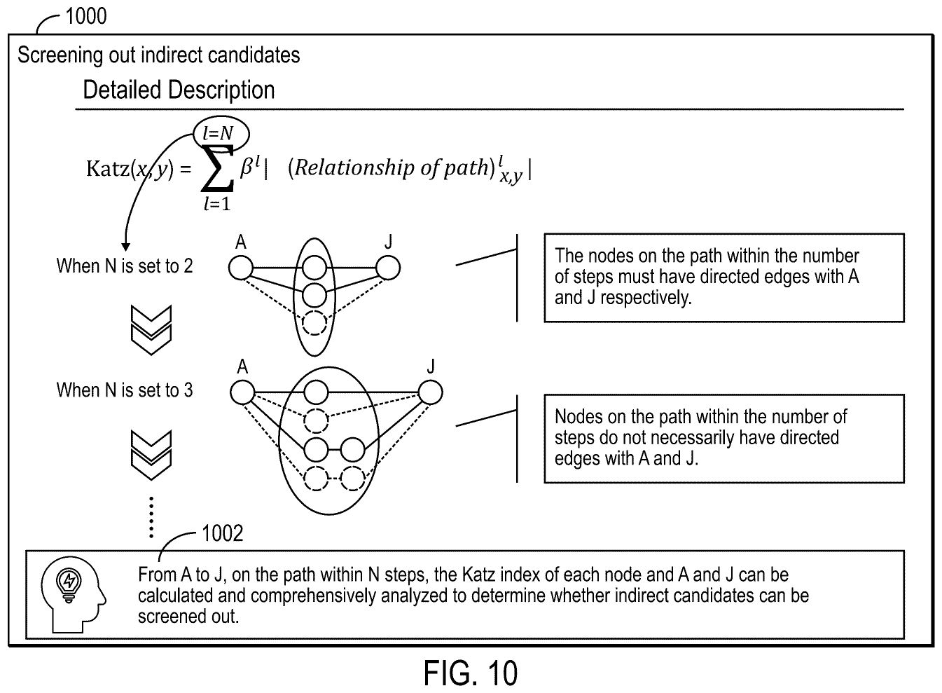

FIG. 10 illustrates a block diagram 1000 that shows mechanisms for screening out indirect candidates, in accordance with certain embodiments. In FIG. 10 an example is provided in which from a node A to J, on a path within N step, the Katz index of each node and A and J are calculated and comprehensively analyzed to determine whether indirect candidates can be screened out (as shown via reference numeral 1002).

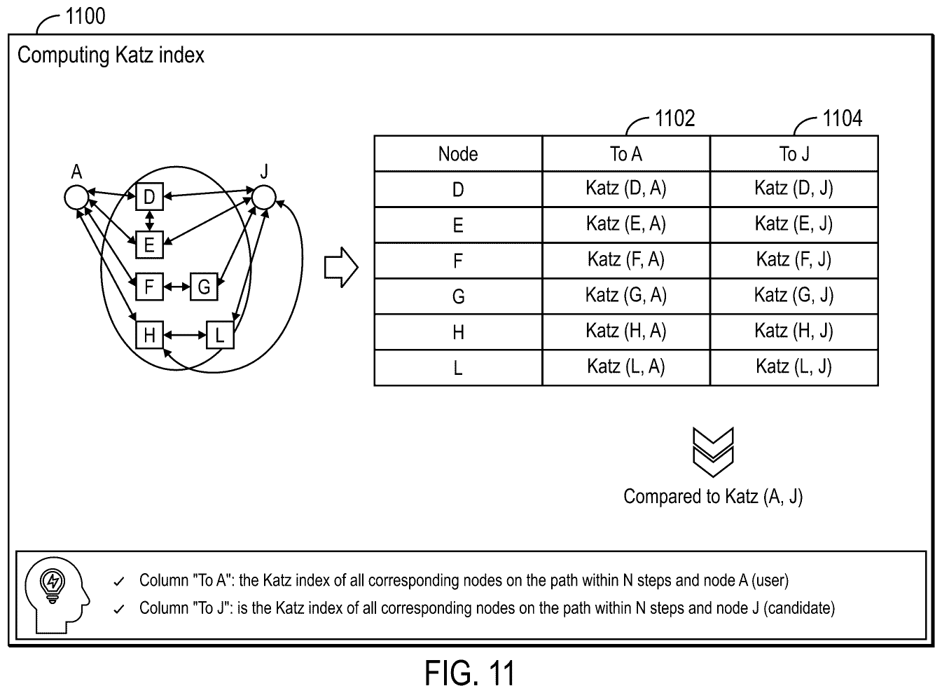

FIG. 11 illustrates a block diagram that shows mechanisms for computing a Katz index, in accordance with certain embodiments. In FIG. 11, the column 1102 labeled “To A” shows the Katz edges of all corresponding nodes on the path within N steps and node A where node A is the user. The column 1104 labeled “To J” shows the Katz index of all corresponding nodes on the path within N steps and node J, where node J is the candidate.

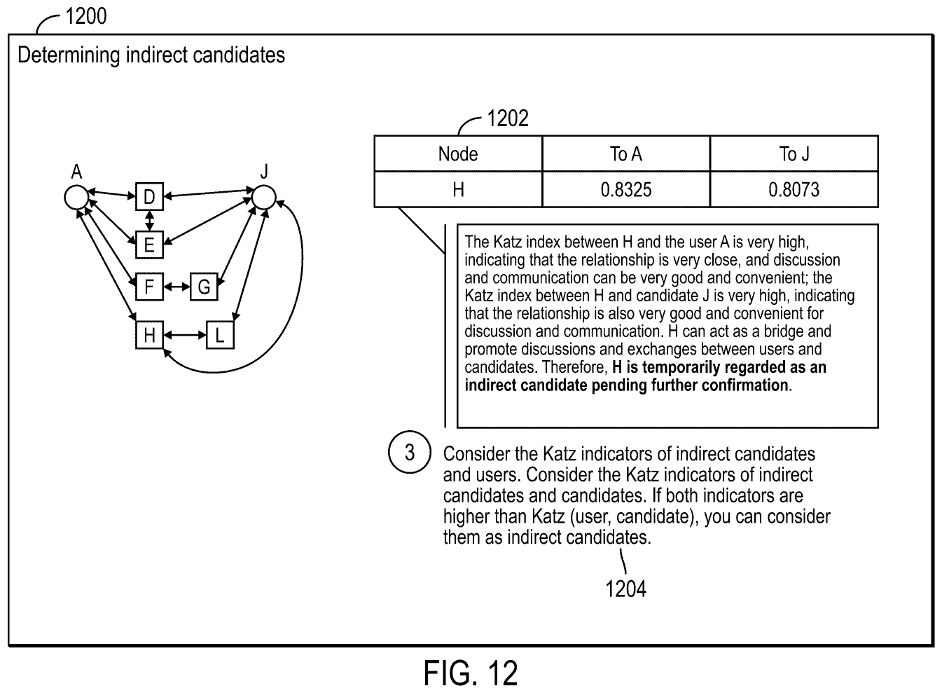

FIG. 12 illustrates a block diagram 1200 that shows mechanisms for determining indirect candidates, in accordance with certain embodiments.

In FIG. 12, reference numeral 1202 shows that the Katz index between H and the user A is very high, indicating that the relationship is very close, and discussion and communication can be very good and convenient; the Katz index between H and candidate J is very high, indicating that the relationship is also very good and convenient for discussion and communication. H can act as a bridge and promote discussions and exchanges between users and candidates. Therefore, H is temporarily regarded as an indirect candidate pending further confirmation.

The process considers the Katz indicators of indirect candidates and users, and consider the Katz indicators of indirect candidates and candidates. If both indicators are higher than Katz (user, candidate), then process considers them as indirect candidates (as shown via reference numeral 1204).

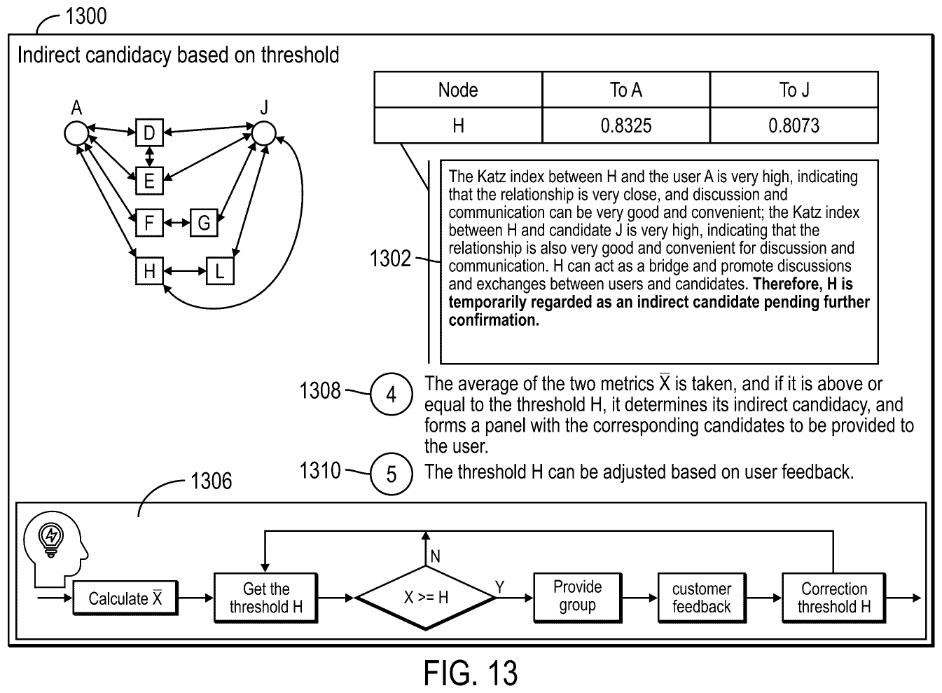

FIG. 13 illustrates a block diagram 1300 that shows mechanisms for indirect candidacy based on a threshold, in accordance with certain embodiments.

In FIG. 13, the Katz index between H and the user A is very high, indicating that the relationship is very close, and discussion and communication can be very good and convenient; the Katz index between H and candidate J is very high, indicating that the relationship is also very good and convenient for discussion and communication. H can act as a bridge and promote discussions and exchanges between users and candidates.

Therefore, H is temporarily regarded as an indirect candidate pending further confirmation (as shown via reference numeral 1302). The flowchart 1306 shows how the average of two metrics is taken to compute indirect candidacy if the average exceeds a threshold H, and how the threshold H can be adjusted based on user feedback (shown via reference numerals 1308, 1310).

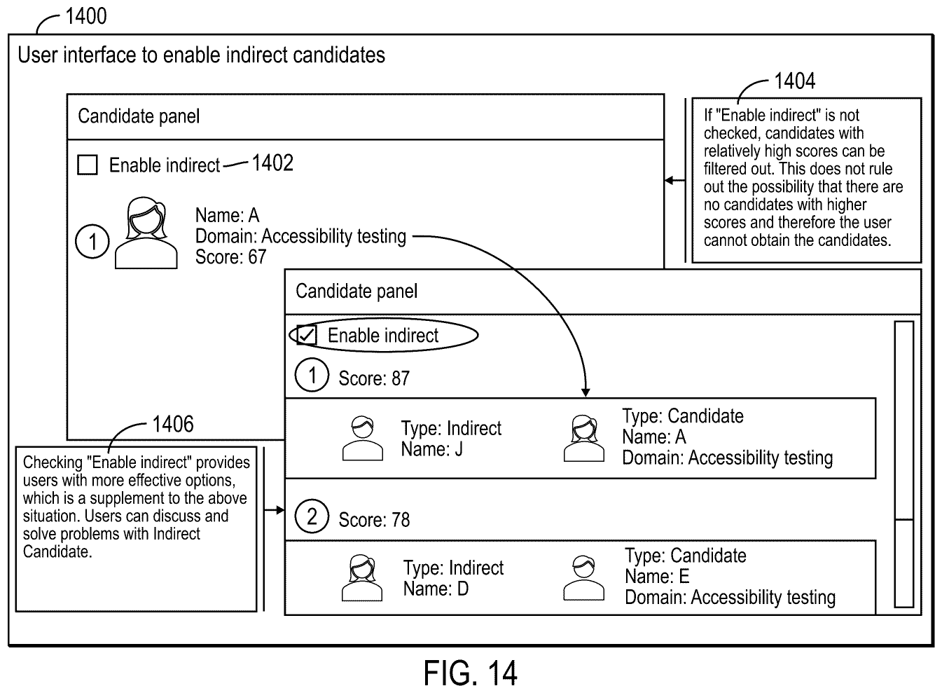

FIG. 14 illustrates a block diagram 1400 that shows a user interface to enable indirect candidates, in accordance with certain embodiments. A checkbox named “enable indirect” 1404 is provided during configuration. If “enable indirect” is not checked (reference numeral 1404) candidates with relatively high scores can be filtered out. This does not rule out the possibility that there are no candidates with higher scores and therefore the user cannot obtain the candidates.

Checking “enable indirect” (reference numeral 1406) provides users with more effective options, which is a supplement to the above situation. Users can discuss and solve problems with indirect candidates.

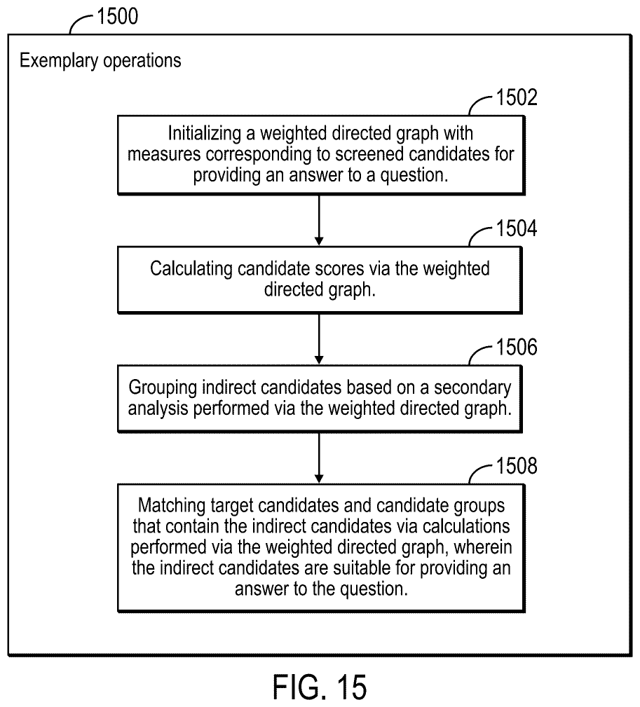

FIG. 15 illustrates a flowchart 1500 that shows exemplary operations, in accordance with certain embodiments.

Control starts at block 1502 in which a weighted directed graph is initialized with measures corresponding to screened candidates for providing an answer to a question.

Candidate scores are calculated (at block 1504) via the weighted directed graph. Indirect candidates are grouped (at block 1506) based on a secondary analysis performed via the weighted directed graph. Target candidates and candidate groups that contain the indirect candidates are matched via calculations performed (at block 1508) via the weighted directed graph, wherein the indirect candidates are suitable for providing an answer to the question.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

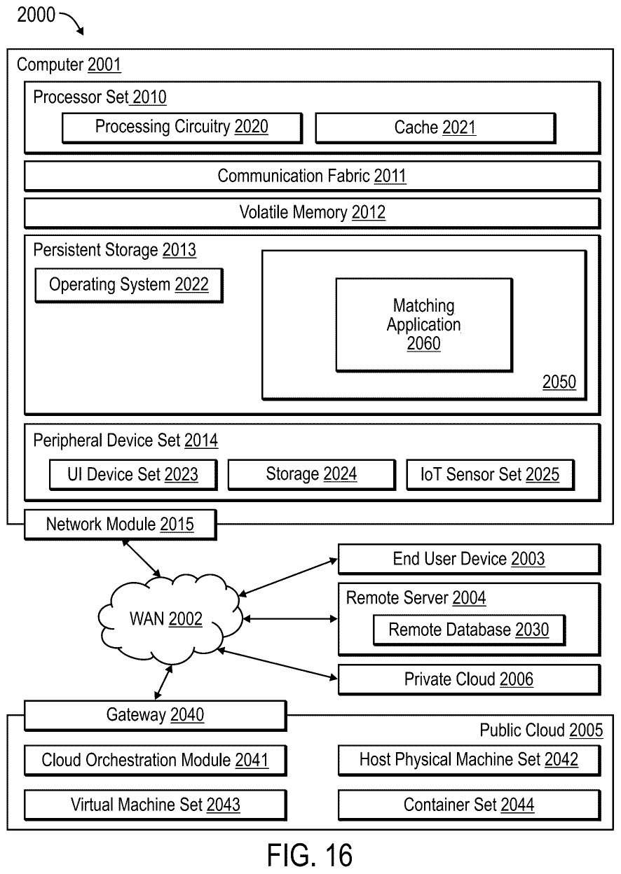

In FIG. 16, a computing environment 2000 contains an example of an environment for the execution of at least some of the computer code (block 2050) involved in performing the operations for a matching application 2060 that performs operations shown in FIGS. 1-15.

In addition to block 2050, computing environment 2000 includes, for example, computer 2001, wide area network (WAN) 2002, end user device (EUD) 2003, remote server 2004, public cloud 2005, and private cloud 2006. In this embodiment, computer 2001 includes processor set 2010 (including processing circuitry 2020 and cache 2021), communication fabric 2011, volatile memory 2012, persistent storage 2013 (including operating system 2022 and block 2050, as identified above), peripheral device set 2014 (including user interface (UI) device set 2023, storage 2024, and Internet of Things (IoT) sensor set 2025), and network module 2015. Remote server 2004 includes remote database 2030. Public cloud 2005 includes gateway 2040, cloud orchestration module 2041, host physical machine set 2042, virtual machine set 2043, and container set 2044.

COMPUTER 2001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 2030. As is well understood in the art of computer technology, and depending upon the technology, performance of a computer-implemented method may be distributed among multiple computers and/or between multiple locations. On the other hand, in this presentation of computing environment 2000, detailed discussion is focused on a single computer, specifically computer 2001, to keep the presentation as simple as possible computer 2001 may be located in a cloud, even though it is not shown in a cloud in FIG. 6. On the other hand, computer 2001 is not required to be in a cloud except to any extent as may be affirmatively indicated.

PROCESSOR SET 2010 includes one, or more, computer processors of any type now known or to be developed in the future. Processing circuitry 2020 may be distributed over multiple packages, for example, multiple, coordinated integrated circuit chips. Processing circuitry 2020 may implement multiple processor threads and/or multiple processor cores. Cache 2021 is memory that is located in the processor chip package(s) and is typically used for data or code that should be available for rapid access by the threads or cores running on processor set 2010. Cache memories are typically organized into multiple levels depending upon relative proximity to the processing circuitry. Alternatively, some, or all, of the cache for the processor set may be located “off chip.” In some computing environments, processor set 2010 may be designed for working with qubits and performing quantum computing.

Computer readable program instructions are typically loaded onto computer 2001 to cause a series of operational steps to be performed by processor set 2010 of computer 2001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 2021 and the other storage media discussed below. The program instructions, and associated data, are accessed by processor set 2010 to control and direct performance of the inventive methods. In computing environment 2000, at least some of the instructions for performing the inventive methods may be stored in block 2050 in persistent storage 2013.

COMMUNICATION FABRIC 2011 is the signal conduction path that allows the various components of computer 2001 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 2012 is any type of volatile memory now known or to be developed in the future. Examples include dynamic type random access memory (RAM) or static type RAM. Typically, volatile memory 2012 is characterized by random access, but this is not required unless affirmatively indicated. In computer 2001, the volatile memory 2012 is located in a single package and is internal to computer 2001, but, alternatively or additionally, the volatile memory may be distributed over multiple packages and/or located externally with respect to computer 2001.

PERSISTENT STORAGE 2013 is any form of non-volatile storage for computers that is now known or to be developed in the future. The non-volatility of this storage means that the stored data is maintained regardless of whether power is being supplied to computer 2001 and/or directly to persistent storage 2013. Persistent storage 2013 may be a read only memory (ROM), but typically at least a portion of the persistent storage allows writing of data, deletion of data and re-writing of data. Some familiar forms of persistent storage include magnetic disks and solid-state storage devices. Operating system 2022 may take several forms, such as various known proprietary operating systems or open-source Portable Operating System Interface-type operating systems that employ a kernel. The code included in block 2050 typically includes at least some of the computer code involved in performing the inventive methods.

PERIPHERAL DEVICE SET 2014 includes the set of peripheral devices of computer 2001. Data communication connections between the peripheral devices and the other components of computer 2001 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 2023 may include components such as a display screen, speaker, microphone, wearable devices (such as goggles and smart watches), keyboard, mouse, printer, touchpad, game controllers, and haptic devices. Storage 2024 is external storage, such as an external hard drive, or insertable storage, such as an SD card. Storage 2024 may be persistent and/or volatile. In some embodiments, storage 2024 may take the form of a quantum computing storage device for storing data in the form of qubits. In embodiments where computer 2001 is required to have a large amount of storage (for example, where computer 2001 locally stores and manages a large database) then this storage may be provided by peripheral storage devices designed for storing very large amounts of data, such as a storage area network (SAN) that is shared by multiple, geographically distributed computers. I/O T sensor set 2025 is made up of sensors that can be used in Internet of Things applications. For example, one sensor may be a thermometer, and another sensor may be a motion detector.

NETWORK MODULE 2015 is the collection of computer software, hardware, and firmware that allows computer 2001 to communicate with other computers through WAN 2002. Network module 2015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 2015 are performed on the same physical hardware device. In other embodiments (for example, embodiments that utilize software-defined networking (SDN)), the control functions and the forwarding functions of network module 2015 are performed on physically separate devices, such that the control functions manage several different network hardware devices. Computer readable program instructions for performing the inventive methods can typically be downloaded to computer 2001 from an external computer or external storage device through a network adapter card or network interface included in network module 2015.

WAN 2002 is any wide area network (for example, the internet) capable of communicating computer data over non-local distances by any technology for communicating computer data, now known or to be developed in the future. In some embodiments, the WAN 2002 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 2003 is any computer system that is used and controlled by an end user (for example, a customer of an enterprise that operates computer 2001), and may take any of the forms discussed above in connection with computer 2001. EUD 2003 typically receives helpful and useful data from the operations of computer 2001. For example, in a hypothetical case where computer 2001 is designed to provide a recommendation to an end user, this recommendation would typically be communicated from network module 2015 of computer 2001 through WAN 2002 to EUD 2003. In this way, EUD 2003 can display, or otherwise present, the recommendation to an end user. In some embodiments, EUD 2003 may be a client device, such as thin client, heavy client, mainframe computer, desktop computer and so on.

REMOTE SERVER 2004 is any computer system that serves at least some data and/or functionality to computer 2001. Remote server 2004 may be controlled and used by the same entity that operates computer 2001. Remote server 2004 represents the machine(s) that collect and store helpful and useful data for use by other computers, such as computer 2001. For example, in a hypothetical case where computer 2001 is designed and programmed to provide a recommendation based on historical data, then this historical data may be provided to computer 2001 from remote database 2030 of remote server 2004.

PUBLIC CLOUD 2005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 2005 is performed by the computer hardware and/or software of cloud orchestration module 2041. The computing resources provided by public cloud 2005 are typically implemented by virtual computing environments that run on various computers making up the computers of host physical machine set 2042, which is the universe of physical computers in and/or available to public cloud 2005. The virtual computing environments (VCEs) typically take the form of virtual machines from virtual machine set 2043 and/or containers from container set 2044. It is understood that these VCEs may be stored as images and may be transferred among and between the various physical machine hosts, either as images or after instantiation of the VCE. Cloud orchestration module 2041 manages the transfer and storage of images, deploys new instantiations of VCEs and manages active instantiations of VCE deployments. Gateway 2040 is the collection of computer software, hardware, and firmware that allows public cloud 2005 to communicate through WAN 2002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 2006 is similar to public cloud 2005, except that the computing resources are only available for use by a single enterprise. While private cloud 2006 is depicted as being in communication with WAN 2002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 2005 and private cloud 2006 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

1. A method, comprising:
determining a candidate list, by a matching application executing in a computational device, from a weighted directed graph stored in the computational device, via a candidate screening module and a candidate group determination module, by operations comprising:
initializing, by the candidate screening module, the weighted directed graph with measures corresponding to screened candidates for providing an answer to a question, wherein for one-way communication activities unidirectional edges are placed in the weighted directed graph, and wherein for two-way communication activities bidirectional edges are placed in the weighted directed graph;
calculating, by the candidate screening module, candidate scores via the weighted directed graph;
grouping, by the candidate group determination module, indirect candidates based on a secondary analysis performed via the weighted directed graph that was initialized by the candidate screening module; and
matching, by the candidate group determination module, target candidates and candidate groups that contain the indirect candidates via calculations performed via the weighted directed graph, wherein the indirect candidates are suitable for providing the answer to the question.

2. The method of claim 1, wherein the calculations include computing Katz index between nodes of the weighted directed graph, wherein each node of the weighted directed graph represents a user or a candidate, and wherein the Katz index that is computed between two nodes of the weighted directed graph is a measure of a relationship between the two nodes of the weighted directed graph.

3. The method of claim 1, wherein in response to encountering the question, a technology area is identified, and in response to identifying the technology area, suitable candidates who can support the technology area are identified and the weighted directed graph initialized, and a Katz metric is calculated to provide scores.

4. The method of claim 3, wherein a candidate group is determined to identify an indirect candidate, subsequent to calculating a Katz indicator.

5. The method of claim 1, the method further comprising:
determining a first Katz indicator of an indirect candidate and a user;
determining a second Katz indicator of the indirect candidate and the candidate; and
in response to determining that both the first and the second Katz indicators are higher than the Katz indicator of the user and the candidate, the indirect candidate is validated as an entity to use.

6. The method of claim 1, wherein for lecture type activities unidirectional edges are placed in the weighted directed graph, and wherein for discussion type activities bidirectional edges are placed in the weighted directed graph.

7. The method of claim 1, wherein a plurality of nodes in a path between two nodes are considered while computing a Katz index for determining an indirect candidate.

8. A system, comprising:
a memory; and
a processor coupled to the memory, wherein the processor performs operations, the operations comprising:
determining a candidate list, by a matching application executing in system, from a weighted directed graph stored in the system, via a candidate screening module and a candidate group determination module, by additional operations comprising:
initializing, by the candidate screening module, the weighted directed graph with measures corresponding to screened candidates for providing an answer to a question, wherein for one-way communication activities unidirectional edges are placed in the weighted directed graph, and wherein for two-way communication activities bidirectional edges are placed in the weighted directed graph;
calculating, by the candidate screening module, candidate scores via the weighted directed graph;
grouping, by the candidate group determination module, indirect candidates based on a secondary analysis performed via the weighted directed graph that was initialized by the candidate screening module; and
matching, by the candidate group determination module, target candidates and candidate groups that contain the indirect candidates via calculations performed via the weighted directed graph, wherein the indirect candidates are suitable for providing the answer to the question.

9. The system of claim 8, wherein the calculations include computing Katz index between nodes of the weighted directed graph, wherein each node of the weighted directed graph represents a user or a candidate, and wherein the Katz index that is computed between two nodes of the weighted directed graph is a measure of a relationship between the two nodes of the weighted directed graph.

10. The system of claim 8, wherein in response to encountering the question, a technology area is identified, and in response to identifying the technology area, suitable candidates who can support the technology area are identified and the weighted directed graph initialized, and a Katz metric is calculated to provide scores.

11. The system of claim 10, wherein a candidate group is determined to identify an indirect candidate, subsequent to calculating a Katz indicator.

12. The system of claim 8, the operations further comprising:
determining a first Katz indicator of an indirect candidate and a user;
determining a second Katz indicator of the indirect candidate and the candidate; and
in response to determining that both the first and the second Katz indicators are higher than the Katz indicator of the user and the candidate, the indirect candidate is validated as an entity to use.

13. The system of claim 8, wherein for lecture type activities unidirectional edges are placed in the weighted directed graph, and wherein for discussion type activities bidirectional edges are placed in the weighted directed graph.

14. The system of claim 8, wherein a plurality of nodes in a path between two nodes are considered while computing a Katz index for determining an indirect candidate.

15. A computer program product, the computer program product comprising a computer readable storage medium, wherein code stored in the computer readable storage medium when executed by a processor performs operations, the operations comprising:
determining a candidate list, by a matching application executing in a computational device, from a weighted directed graph stored in the computational device, via a candidate screening module and a candidate group determination module, by additional operations comprising:
initializing, by the candidate screening module, the weighted directed graph with measures corresponding to screened candidates for providing an answer to a question, wherein for one-way communication activities unidirectional edges are placed in the weighted directed graph, and wherein for two-way communication activities bidirectional edges are placed in the weighted directed graph;
calculating, by the candidate screening module, candidate scores via the weighted directed graph;
grouping, by the candidate group determination module, indirect candidates based on a secondary analysis performed via the weighted directed graph that was initialized by the candidate screening module; and
matching, by the candidate group determination module, target candidates and candidate groups that contain the indirect candidates via calculations performed via the weighted directed graph, wherein the indirect candidates are suitable for providing the answer to the question.

16. The computer program product of claim 15, wherein the calculations include computing Katz index between nodes of the weighted directed graph, wherein each node of the weighted directed graph represents a user or a candidate, and wherein the Katz index that is computed between two nodes of the weighted directed graph is a measure of a relationship between the two nodes of the weighted directed graph.

17. The computer program product of claim 15, wherein in response to encountering the question, a technology area is identified, and in response to identifying the technology area, suitable candidates who can support the technology area are identified and the weighted directed graph initialized, and a Katz metric is calculated to provide scores.

18. The computer program product of claim 17, wherein a candidate group is determined to identify an indirect candidate, subsequent to calculating a Katz indicator.

19. The computer program product of claim 15, the operations further comprising:
determining a first Katz indicator of an indirect candidate and a user;
determining a second Katz indicator of the indirect candidate and the candidate; and
in response to determining that both the first and the second Katz indicators are higher than the Katz indicator of the user and the candidate, the indirect candidate is validated as an entity to use.

20. The computer program product of claim 15, wherein for lecture type activities unidirectional edges are placed in the weighted directed graph, and wherein for discussion type activities bidirectional edges are placed in the weighted directed graph.
